(19) United States
(12) Patent Application Publication
(10) Pub. No.: US 2025/0065648 A1
(43) Pub. Date: Feb. 27, 2025

(54) DRYING APPARATUS

(71) Applicant: KYOCERA Document Solutions Inc., Osaka (JP)

(72) Inventors: Mitsuhiro GODA, Osaka-shi (JP); Masaki MURASHIMA, Osaka-shi (JP); Hiroyuki UEDA, Osaka-shi (JP); Minoru TOKONAMI, Osaka-shi (JP)

(73) Assignee: KYOCERA Document Solutions Inc., Osaka (JP)

(21) Appl. No.: 18/783,376

(22) Filed: Jul. 24, 2024

(30) Foreign Application Priority Data
Aug. 22, 2023 (JP) 2023-134656

(51) Int. Cl. B41J 11/00

(52) U.S. Cl. CPC B41J 11/00222; B41J 11/00216; B41J 11/007

(57) ABSTRACT

A drying apparatus dries a recording medium on which an image is formed, while conveying the recording medium. The drying apparatus includes a conveying member, a heating device, and a drying chamber, and a path. The conveying member supports and conveys the recording medium in a predetermined conveyance direction. The heating device heats the recording medium conveyed by the conveying member under a high-temperature environment. The drying chamber is arranged on an upstream side of the heating device in the conveyance direction of the recording medium and pre-dries the recording medium conveyed by the conveying member. The path communicates the heating device with the drying chamber.

### INCORPORATION BY REFERENCE

This application is based on and claims the benefit of priority from Japanese patent application No. 2023-134656 filed on Aug. 22, 2023, which is incorporated by reference in its entirety.

### BACKGROUND

The present disclosure relates to a drying apparatus which dries a recording medium on which an image is formed by an inkjet recording method, while conveying the recording medium.

An image forming system including an inkjet type image forming apparatus is provided with a drying apparatus which dries an image formed on a recording medium by ink. The drying apparatus generally includes a heater which emits infrared ray. For example, the drying apparatus may include a first drying means and a second drying means which emit infrared ray. The first drying means and the second drying means are arranged sequentially in a conveyance direction of a sheet (a recording medium). By selectively irradiating the sheet with the first heating means based on information about the sheet, a drying efficiency is enhanced.

However, in the above-described drying apparatus using infrared ray, when the recording medium is irradiated with infrared ray rapidly, there is a case in which the ink boils and crust generated by busting the bubbles is generated. Alternatively, surface cracks in the coated paper may occur due to the sudden evaporation and expansion of moisture contained in the recording medium. Furthermore, a hole unevenness of a conveying belt may occur due to a temperature difference around the through-hole of the conveying belt.

Therefore, the drying apparatus is generally configured so as not to rapidly dry the recording medium by weakening an output of the heater and increasing a conveying distance of the recording medium. However, in such a configuration, there is a problem that a size of the drying apparatus increases and a number of the heaters increases, thereby increasing the cost and power consumption.

### SUMMARY

A drying apparatus according to the present embodiment dries a recording medium on which an image is formed, while conveying the recording medium. The drying apparatus includes a conveying member, a heating device, a drying chamber, and a path. The conveying member supports and conveys the recording medium in a predetermined conveyance direction. The heating device heats the recording medium conveyed by the conveying member under a high-temperature environment. The drying chamber is arranged on an upstream side of the heating device in the conveyance direction of the recording medium and pre-dries the recording medium conveyed by the conveying member. The path communicates the heating device with the drying chamber.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view showing an inside of the drying apparatus according to one embodiment of the present disclosure.

FIG. 2 is a front view explaining a flow of air in a drying chamber in the drying apparatus according to the embodiment of the present disclosure.

### DETAILED DESCRIPTION

Hereinafter, with reference to the drawings, a drying apparatus according to one embodiment of the present disclosure will be described.

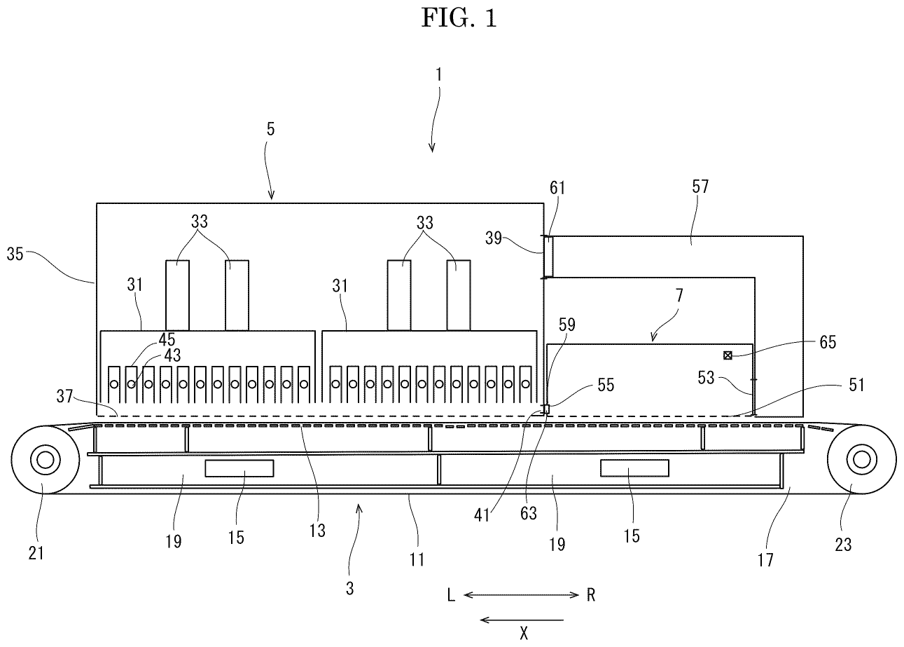

First, the entire structure of the drying apparatus 1 will be described with reference to FIG. 1. FIG. 1 is a front view showing the inside of the drying apparatus 1. In each figure, L and R indicate the left side and the right side of the drying apparatus 1, respectively.

The drying apparatus 1 includes a conveying device 3 which conveys a recording medium on which an image is formed by an inkjet method, a heating device 5 which dries an image (ink) formed on the recording medium conveyed by the conveying device 3 under a high-temperature environment, and a drying chamber 7 which pre-dries the recording medium before drying the ink by the heating device 5.

First, the conveying device 3 will be described. The conveying device 3 includes a conveying belt 11 which conveys the recording medium along a conveyance direction X from the right to the left in FIG. 1, a conveying plate 13 which supports the conveying belt 11, a suction device 15 which attracts the recording medium to the conveying belt 11, and front and rear side plates 17 which support them.

First, the front and rear side plates 17 will be described. The front and rear side plates 17 are plate-like members elongated in a width direction (a direction intersecting the conveyance direction X, the left-and-right direction), and are arranged at an interval in the front-and-rear direction. Two rooms 19 arranged in the conveyance direction X are formed in the lower portion of the space between the front and rear side plates 17.

A driving roller 21 and a driven roller 23 are supported between the front and rear side plates 17. The driving roller 21 is rotatably supported at the downstream side end portions (the left end portions) of the front and rear side plates 17 in the conveyance direction X. The driven roller 23 is rotatably supported at the upstream side end portions (the right end portions) of the front and rear side plates 17 in the conveyance direction. The drive shaft of the driving roller 21 is connected to a motor (not shown).

Next, the conveying belt 11 will be described. The conveying belt 11 is an endless belt, and a number of through-holes penetrating in the thickness direction are formed on the entire surface. The conveying belt 11 is wound around the driving roller 21 and the driven roller 23. When the driving roller 21 is driven by the motor to be rotated, the conveying belt 11 circulates and travels in the counterclockwise direction of FIG. 1. The outer surface of the conveying belt 11 along the upper track is a conveying surface on which the recording medium is conveyed. As described above, the conveying belt 11 is an example of the conveying member conveying the recording medium in the present disclosure.

Next, the conveying plate 13 will be described. The conveying plate 13 is supported by the front and rear side plates 17 so as to be in contact with the inner circumferential surface (the surface opposite to the conveying surface) of the conveying belt 11 traveling on the upper track. When the conveying belt 11 travels, the inner circumferential surface of the conveying belt 11 slides along the upper surface of the conveying plate 13. A number of through-holes penetrating in the thickness direction are formed on the entire surface of the conveying plate 13.

Next, the suction device 15 will be described. The suction device 15 is disposed in each of the two rooms 19 formed between the front and rear side plates 17. When the suction device 15 is driven, air in the through-holes of the conveying belt 11 and the through-holes of the conveying plate 13 is evacuated. Thus, the recording medium on the conveying surface of the conveying belt 11 is attracted to the conveying belt 11.

Next, the heating device 5 will be described. The heating device 5 includes two heater units 31, two fans 33 provided in each heater unit 31, and a housing 35 in which they are housed.

The housing 35 is formed in a box shape with an open lower surface. The opening of the lower surface is covered with a protective net 37. In the upper portion of the upstream-side side plate (the right side plate) of the housing 35 in the conveyance direction X, an upper opening 39 is formed, and in the lower portion of the upstream-side side plate, a lower opening 41 is formed.

The two heater units 31 are arranged side by side in the conveyance direction X in the hollow space of the housing 35. Each heater unit 31 includes a plurality of infrared heaters 43 arranged side by side in the conveyance direction X, and a reflector 45 for reflecting infrared ray emitted from each infrared heater 43. Infrared ray emitted from the infrared heater 43 is reflected by the reflector 45 and irradiated downward. The upper opening 39 formed in the right side plate of the housing 35 is arranged above the heater units 31. On the other hand, the lower opening 41 formed in the right side plate of the housing 35 is arranged below the heater units 31.

The two fans 33 are provided on the upper surface (the top surface) of each heater unit 31. The fan 33 takes in air in the housing 35 and blows it downward. The downward blown air is heated by passing through the heater units 31 to generate downward hot air.

The heating device 5 is arranged above the downstream side portion of the conveying surface of the conveying belt 11 of the conveying device 3. Between the heating device 5 and the conveying surface, a predetermined gap is formed.

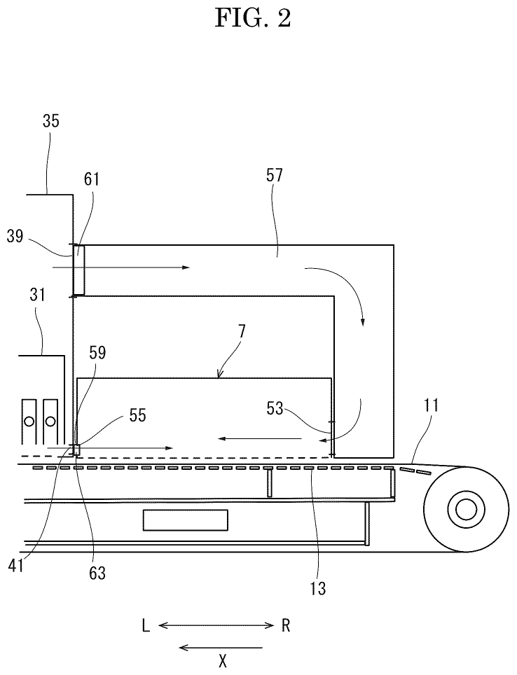

Next, the drying chamber 7 will be described with reference to FIG. 2. FIG. 2 is a front view showing the drying chamber 7. The drying chamber 7 is formed in a box-like shape with an open lower surface, which is smaller in height and length (along the conveyance direction X) than the housing 35 of the heating device 5. The opening of the lower surface is covered with a protective net 51. In the lower portion of the upstream-side side plate (the right side plate) of the drying chamber 7, an upstream side opening 53 is formed, and in the lower portion of the downstream-side side plate (the left side plate) of the drying chamber 7, a downstream side opening 55 is formed. The upstream side opening 53 and the downstream side opening 55 face each other in the conveyance direction X.

The drying chamber 7 is disposed above the conveying surface of the conveying belt 11 of the conveying device 3 at a predetermined distance from the conveying surface, on the upstream side of the heating device 5 in the conveyance direction. As described above, the drying chamber 7 and the heating device 5 are arranged side by side in order along the conveyance direction X. The upstream side opening 53 of the drying chamber 7 communicates with the upper opening 39 of the housing 35 of the heating device 5 through an upper duct 57. The upper duct 57 extends horizontally upstream from the upper opening 39 above the top plate of the drying chamber 7, and then bends downward along the upstream-side side plate of the drying chamber 7 to communicate with the upstream side opening 53. The downstream side opening 55 of the drying chamber 7 communicates with the lower opening 41 of the housing 35 of the heating device 5 through a lower duct 59. As described above, the upper duct 57 and the lower duct 59 are examples of the upper and lower paths communicating the heating device 5 and the drying chamber 7 in the present disclosure.

An upper blower fan 61 is provided at the inlet of the upper duct 57. A lower blower fan 63 is provided in the lower duct 59.

The drying operation of the drying apparatus 1 having the above structure will be described. In the conveying device 3, the driving roller 21 is driven to be rotated, and the conveying belt 11 travels. Thereafter, the recording medium on which the image is formed by the inkjet method is conveyed on the conveying surface of the conveying belt 11. The suction device 15 is driven. Thereby, as described above, air in the through-holes of the conveying belt 11 and the through-holes of the conveying plate 13 is evacuated, and the space above the conveying surface of the conveying belt 11 becomes negative pressure. Thus, the recording medium is attracted to the conveying surface. Thus, the recording medium is conveyed along the conveyance direction X while being attracted to the conveying surface.

Further, the heater units 31 and the fans 33 of the heating device 5 are driven. As described above, infrared ray emitted from the infrared heater 43 is reflected by the reflector 45 and irradiated downward. The air blown downward by the fan 33 passes through the heater units 31, and is heated to generate downward hot air. Thus, the heating device 5 blows the heated air (hot air) downward. Further, the heater units 31 are driven to increase the temperature inside the housing 35 of the heating device 5.

Further, the upper blower fan 61 and the lower blower fan 63 are driven. Then, as shown by the arrow in FIG. 2, the air in the upper space (the space above the heater units 31) in the housing 35 enters the upper duct 57 through the upper opening 39, and flows into the drying chamber 7 from the upstream side opening 53 through the upper duct 57 by the upper blower fan 61. Further, the heated air in the space below the heater units 31 enters the lower duct 59 through the lower opening 41 by the lower blower fan 63, and flows into the drying chamber 7 through the downstream side opening 55. As a result, the temperature in the drying chamber 7 increases. However, since the temperature of the space above the housing 35 is lower than the temperature of the space below the heater units 31, the temperature in the drying chamber 7 is lower than the temperature of the hot air blown out from the heating device 5.

Since the upstream side opening 53 and the downstream side opening 55 are arranged facing each other, the air flowing in from the upstream side opening 53 (the outlet port of the upper duct 57 to the drying chamber 7) and the downstream side opening 55 (the outlet port of the lower duct 59 to the drying chamber 7) collides with each other in the central portion of the drying chamber 7, and the wind speeds of the two air flows are decreased. Thus, the air flowing into the drying chamber 7 is easily stayed. The heated air flowing into the drying chamber 7 leaks downward from the drying chamber 7.

Then, the recording medium conveyed on the conveying surface of the conveying belt 11 is first exposed to the leaked heated air, and the ink of the recording medium is preliminarily dried. Since the temperature of the heated air is not so high as to boil the ink and the wind speed is slower than the hot air blown out from the heating device 5, the ink is supplementarily dried. Thereafter, the recording medium is conveyed from below the drying chamber 7 to below the heating device 5. Thus, the pre-dried ink is completely dried.

As is clear from the above description, according to the drying apparatus 1 of the present disclosure, the ink can be dried without rapidly increasing the temperature, thereby reducing the above-mentioned problems (the crust, the surface cracks in the coated paper, and the hole unevenness of the conveying belt). Further, since it is not necessary to lengthen the length of the conveying surface of the conveying belt 11, enlargement of the drying apparatus 1 can be prevented. Furthermore, since a number of the heater units 31 can be reduced, the cost and power consumption can be reduced.

Furthermore, since the temperature of the air in the drying chamber 7 can be increased to an appropriate temperature by using the air whose temperature is increased by the heating device 5, there is no need to provide a mechanism for increasing the temperature of the air in the drying chamber 7 separately.

Further, as described above, since the air leaked out of the drying chamber 7 has a lower temperature and a slower wind speed than the hot air blown out of the heating device 5, the ink can be dried without rapidly increasing the temperature. Since the air flowing into the drying chamber 7 is difficult to escape from the drying chamber 7, the pre-drying can be performed efficiently.

A temperature sensor 65 (see FIG. 1) may be arranged in the drying chamber 7 to control the driving of the upper and lower blower fans 61 and 63 based on the temperature measured by the temperature sensor 65. For example, when the temperature in the drying chamber 7 is lower than a predetermined temperature, the rotation speed of the lower blower fan 63 is increased so that the air having a higher temperature below the heater units 31 is taken into the drying chamber 7.

Although the present disclosure has been described in particular embodiments, the present disclosure is not limited to the foregoing embodiments. To the extent that it does not deviate from the scope and object of the present disclosure, the foregoing embodiments may be variously modified, substituted, or modified, and the claims include all embodiments that may fall within the scope of technical thought.

1. A drying apparatus which dries a recording medium on which an image is formed, while conveying the recording medium, the drying apparatus comprising:
a conveying member which supports and conveys the recording medium in a predetermined conveyance direction;
a heating device which heats the recording medium conveyed by the conveying member under a high-temperature environment;
a drying chamber which is arranged on an upstream side of the heating device in the conveyance direction of the recording medium and pre-dries the recording medium conveyed by the conveying member; and
a path which communicates the heating device with the drying chamber.

2. The drying apparatus according to claim 1, wherein,
the heating device includes:
a fan which takes in air from an outside and blows the air toward the recording medium conveyed by the conveying member;
a heater which is disposed on a downstream side of the fan in an air blowing direction and irradiates infrared ray toward the recording medium conveyed by the conveying member; and
a housing in which the fan is disposed on a top surface and the heater is housed, wherein
the path includes an upper path communicating a space of the housing on an upstream side of the fan in the blowing direction with the drying chamber, and a lower path communicating a space between the heater and the conveying member with the drying chamber, and
an outlet port of the upper path to the drying chamber faces an outlet port of the lower path to the drying chamber.

3. The drying apparatus of claim 1, wherein
the path is provided with a fan for sending air from the heating device to the drying chamber.

4. The drying apparatus according to claim 1, comprising:
a temperature sensor which detects a temperature in the drying chamber, and
an amount of air sent into the drying chamber is controlled based on the temperature in the drying chamber detected by the temperature sensor.
